(19) United States
(12) Patent Application Publication
(10) Pub. No.: US 2015/0229112 A1
(43) Pub. Date: Aug. 13, 2015

(54) TOW LIGHT HARNESS SECURING DEVICE

(71) Applicant: Mary Ellen Farnham, Henderson, NV (US)

(72) Inventor: Mary Ellen Farnham, Henderson, NV (US)

(21) Appl. No.: 14/178,563

(22) Filed: Feb. 12, 2014

(51) Int. Cl. H02G 3/32

(52) U.S. Cl. CPC H02G 3/32

(57) ABSTRACT

A tow light harness securing device to fasten a tow light harness against an exterior surface of a vehicle comprising: a base; a suction cup attached below the base, where the suction cup attaches to the exterior surface of the vehicle; and a clip extending from the base, where the clip receives the tow light harness to secure the tow light harness against the exterior surface of the vehicle.

### BACKGROUND OF THE INVENTION

1. Field of the Invention

The present invention relates to a device to secure a harness from a tow light to ensure that the wires do not scratch the exterior surface of the vehicle.

2. Description of Related Art

Hitching a trailer is a common procedure performed by many individuals owning or driving a variety of vehicles. Some trailers are hitched to a truck with a tow hitch attached to the chassis of the truck, traditionally referred to as bumper-pull hitches. These trailers may accommodate pulling a vehicle, a storage unit or even a boat. Towing a secondary vehicle behind an RV is common to allow access to a common vehicle once the RV is parked. Typically the vehicle is mounted on a trailer behind the RV and then the trailer is hitched to the RV for towing.

A connector on the tow electrically couples the wiring harness of a vehicle to the RV, or other towing vehicle. During transport, the wires and cables from the harness hang from the connection point, flapping in the wind as the vehicles move. Often the flapping may cause scratching or permanent damage to the vehicle resulting in costly repairs. Some people may try to tighten the wiring between the vehicle and the RV but that usually results in a disconnection in the wires, thereby creating dangerous driving conditions for surrounding drivers.

Based on the foregoing, it would be beneficial in the art to provide a way to secure a vehicle tow light harness to prevent damage to the vehicle's exterior. It would also be desirable in the art to provide a holder that gives and takes during use to prevent disconnection of the harness while towing.

### SUMMARY OF THE INVENTION

In view of the foregoing disadvantages inherent in the prior art, the general purpose of the present invention is to provide a tow light harness securing device to fasten a tow light harness against an exterior surface of a vehicle, configured to include all of the advantages of the prior art, and to overcome the drawbacks inherent therein.

Accordingly, an object of the present invention is to provide a tow light harness securing device to attach a harness of a tow light to a vehicle utilizing a suction cup attachment.

Another object of the present invention is to provide a tow light harness securing device with a spring clip that receives the harness to quickly and easily attach the harness.

To achieve the above objects, in an aspect of the present invention, a tow light harness securing device is described comprising: a base; a suction cup attached below the base, where the suction cup attaches to the exterior surface of the vehicle; and a clip extending from the base, where the clip receives the tow light harness to secure the tow light harness against the exterior surface of the vehicle.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWING

The advantages and features of the present invention will become better understood with reference to the following detailed description and claims taken in conjunction with the accompanying drawing which:

FIG. 1 depicts a perspective view of a tow light harness securing device in accordance with an exemplary embodiment of the present invention.

### DETAILED DESCRIPTION OF THE DRAWING

The present invention relates to a device to secure a harness from a tow light to ensure that the wires do not scratch the exterior surface of the vehicle. The present invention relates to a vehicle protector to prevent a tow light harness from brush up and/or hitting a vehicle. The tow light harness securing device includes a suction cup with a flexible spring clamp. The spring clamp holds the harness or wiring cable from the tow light. During use, the suction cup is fastened against the vehicle, and the tow light harness is secured within the spring clamp to prevent the harness from flapping and causing damage to the vehicle exterior.

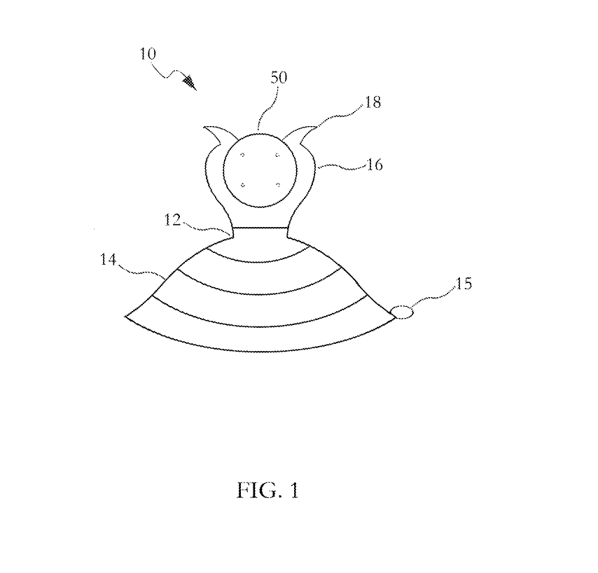

Turning now descriptively to the drawings, referring to FIG. 1, a tow light harness securing device 10 is shown in accordance with an exemplary embodiment of the present invention. The tow light harness securing device 10 includes a base 12 which is fastened atop a suction cup 14. The suction cup 14 includes a pull tab 15 to release the suction pressure when the suction cup 14 is attached to a vehicle. The suction cup 14 may range from 1.5-3 inches in diameter.

From the base 12 extends a spring clip 16. The spring clip 16 may receive a tow light harness 50 or cables between its U-shaped arms. The spring clip 16 includes an outward protrusion 18 at the end of each arm. The outward protrusion 18 guides the harness 50 easily into the spring clip 16 for fastening. Also, the outward protrusion 18 provides a lever to pull to release the harness 50 from between the spring clip 16. The spring clip 16 accommodates flexion and movement of the harness 50 while attached to the vehicle.

The tow light harness securing device 10 easily receives a tow harness 50 to anchor the harness to a vehicle during transport. The base 12 of the device 10 may be metallic for additional strength in securing the harness 50. The suction cup 14 may be plastic or rubber to provide the flexible suction needed for attachment. Finally, the dual armed clip 16 may be steel, aluminum, hardened plastic or the like to ensure the harness 50 does not detach until released. With the tow light harness securing device 10 the harness of a tow light or other accessory wires are fastened against the exterior of the vehicle to prevent the harness or wires from dangling, hitting and damaging the vehicle's exterior.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A tow light harness securing device to fasten a tow light harness against an exterior surface of a vehicle comprising:
a. a base;
b. a suction cup attached below the base, where the suction cup attaches to the exterior surface of the vehicle; and
c. a clip extending from the base, where the clip receives the tow light harness to secure the tow light harness against the exterior surface of the vehicle.

2. The tow light harness securing device according to claim 1, where the suction cup includes a pull tab to release the suction cup after use.

3. The tow light harness securing device according to claim 1, where the clip is a spring clip.

4. The tow light harness securing device according to claim 3, where the spring clip includes an outward protrusion to guide the harness into the spring clip.
